(19) United States
(12) Patent Application Publication
(10) Pub. No.: US 2013/0325672 A1
(43) Pub. Date: Dec. 5, 2013

(54) MOBILE FORECASTING OF SALES USING CUSTOMER STOCK LEVELS IN A SUPPLIER BUSINESS SYSTEM

(71) Applicants: Jens Odenheimer, Karlsruhe (DE); Peter Eberlein, Malsch (DE)

(72) Inventors: Jens Odenheimer, Karlsruhe (DE); Peter Eberlein, Malsch (DE)

(73) Assignee: SAP AG, Walldorf (DE)

(21) Appl. No.: 13/484,948

(22) Filed: May 31, 2012

(51) Int. Cl. G06Q 10/08

(52) U.S. Cl. 705/28

(57) ABSTRACT

The disclosure generally describes computer-implemented methods, software, and systems for modeling and deploying decision services. One computer-implemented method includes selecting an account for a purchaser in a graphical user interface (GUI), entering a current stock level for a product associated with the selected account in an inventory mode in the GUI, presenting received calculated information associated with the product, exiting the inventory mode in the GUI, generating replenishment sales order data, and creating a replenishment sales order for the product.

### TECHNICAL FIELD

The present disclosure relates to computer-implemented methods, software, and systems for mobile forecasting of sales based on historical customer business data.

### BACKGROUND

A supplier transacts with a purchaser to provide products. The supplier and the purchaser typically archive transactional business data and other associated data for various reasons, including future sales/restocking, customer support, compliance with government rules and regulations, taxes, etc. This archived data may be very valuable to both a supplier and a purchaser. For example, knowledge of a purchaser's real-time product stock level coupled with the purchaser's prior purchase orders could allow a supplier to proactively and more accurately engage in re-supply efforts of the product with the purchaser increasing the product turnover rate. Suppliers and purchasers, however, often choose to keep this type of data private or lack the infrastructure to distribute it. This lack of knowledge sharing affects the efficiency of both the supplier and purchaser with respect to providing/receiving products and the ability to quickly adapt to real-time market or other conditions.

### SUMMARY

The present disclosure relates to computer-implemented methods, software, and systems for mobile forecasting of sales based on historical customer business data. One computer-implemented method includes selecting an account for a purchaser in a graphical user interface (GUI), entering a current stock level for a product associated with the selected account in an inventory mode in the GUI, presenting received calculated information associated with the product, exiting the inventory mode in the GUI, generating replenishment sales order data, and creating a replenishment sales order for the product.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising requesting initial information associated with the selected purchaser account from a data source.

A second aspect, combinable with any of the previous aspects, further comprising creating a connection with the data source to request the initial information.

A third aspect, combinable with any of the previous aspects, further comprising retrieving a last sales order for the product.

A fourth aspect, combinable with any of the previous aspects, further comprising calculating an average sales volume.

A fifth aspect, combinable with any of the previous aspects, further comprising calculating a suggested replenishment quantity for the product.

In a sixth aspect, combinable with any of the previous aspects, the received calculated information associated with the product includes at least one of an average sales volume or a suggested replenishment quantity.

A seventh aspect, combinable with any of the previous aspects, further comprising: determining that the suggested replenishment quantity is not acceptable; and overriding the suggested replenishment quantity.

The subject matter described in this specification can be implemented in particular implementations so as to realize one or more of the following advantages. First, a supplier can provide a purchaser product-specific sales forecasts to optimize a purchasers use of valuable business resources. Second, a supplier can automate restocking requests to be approved by the purchaser saving time and allowing both the supplier and purchaser to be more agile and increase product turnover rate. Third, the supplier can provide a purchaser additional inventory management and historical context/insight associated with their inventory. Fourth, suppliers gain invaluable insights into real-time product-specific stock level data for a customer and can perform business analytics on this data. Fifth, suppliers gain access to business data providing information on specific products including when sold, by whom, for what price, etc. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for mobile forecasting of sales based on historical customer business data.

FIG. 2 is a block diagram further illustrating an example system for mobile forecasting of sales based on historical customer business data.

FIG. 3 illustrates an example graphical user interface screenshot from a client application.

FIG. 4 is a flow chart for mobile forecasting of sales based on historical customer business data.

Like reference numbers and designations in the various drawings indicate like elements.

### DETAILED DESCRIPTION

The disclosure generally describes computer-implemented methods, software, and systems for mobile forecasting of sales based on historical customer business data.

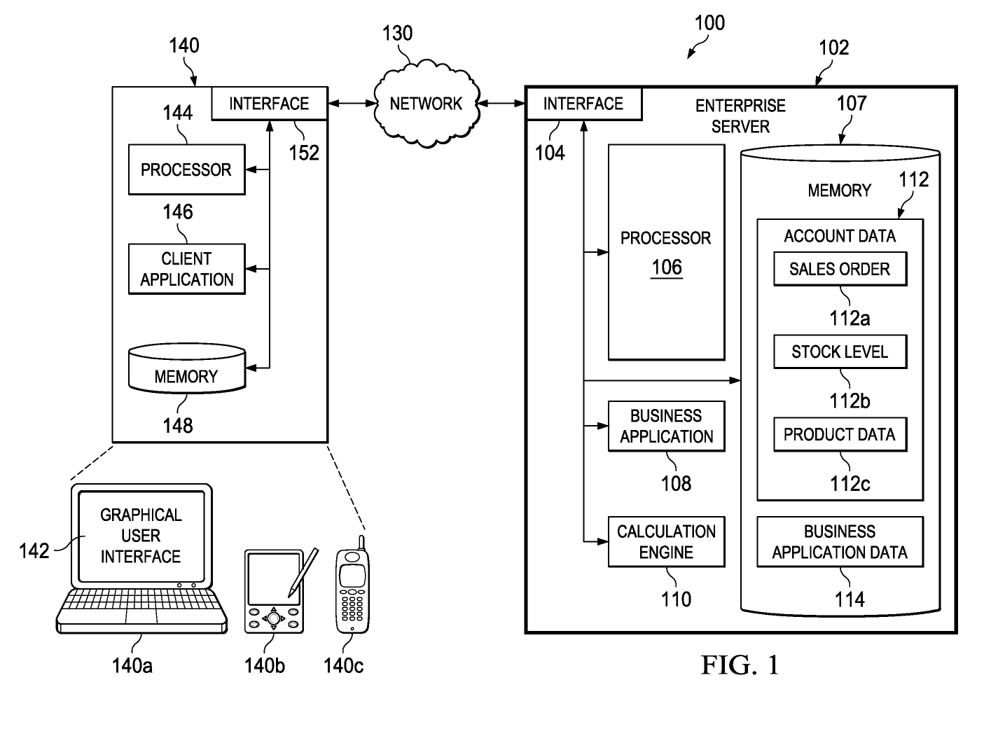

FIG. 1 illustrates an example distributed computing system 100 operable to forecast sales based on historical customer business data using a mobile device. Specifically, the illustrated example distributed computing system 100 includes or is communicably coupled with an enterprise server 102 and a client 140 that communicate across a network 130.

At a high level, the enterprise server 102 allows forecasting of sales using a mobile device based on historical customer business data and comprises an electronic computing device operable to receive, transmit, process, store, or manage data and information associated with the example distributed computing system 100. Generally, through a graphical user interface (GUI), the enterprise server 102 user, for example using the client 140, is provided with an efficient and user-friendly presentation of data provided by or communicated within the example distributed computing system 100.

In general, the enterprise server 102 is a server that stores a business application 108 and a calculation engine 110, where at least a portion of the business application 108 and/or the calculation engine 110 is executed using requests and responses sent to a client 140 within and communicably coupled to the illustrated example distributed computing system 100 using network 130. The business application 108 and/or calculation engine 110 are used to identify and communicate with one or more clients 140. In some implementations, the enterprise server 102 may store a plurality of various business applications 108 and/or calculation engines 110. In other implementations, the enterprise server 102 may be a dedicated server meant to store and execute only a single business application 108 and/or a calculation engine 110. In some implementations, the enterprise server 102 may comprise a web server, where the business application 108 and/or the calculation engine 110 represents one or more web-based applications accessed and executed by the client 140 using the network 130 or directly at the enterprise server 102 to perform the programmed tasks or operations of the business application 108 and/or the calculation engine 110.

Specifically, the enterprise server 102 is responsible for receiving requests, for example product reorder and product reorder quantity requests, from one or more client applications associated with the client 140 of the example distributed computing system 100, and responding to the received requests by processing said requests in the associated business application 108 and/or calculation engine 110, and sending an appropriate response from the business application 108 and/or calculation engine 110 back to the requesting client application associated with the client 140. In addition to requests from the client 140, requests associated with the business application 108 and/or calculation engine 110 may also be sent from internal users, external or third-party customers, other automated applications, as well as any other appropriate entities, individuals, systems, or computers. According to one implementation, enterprise server 102 may also include or be communicably coupled with an e-mail server, a web server, a caching server, a streaming data server, and/or other suitable server. In other implementations, the enterprise server 102 and related functionality may be provided in a cloud-computing environment.

As illustrated in FIG. 1, the enterprise server 102 includes an interface 104. Although illustrated as a single interface 104 in FIG. 1, two or more interfaces 104 may be used according to particular needs, desires, or particular implementations of the example distributed computing system 100. The interface 104 is used by the enterprise server 102 for communicating with other systems in a distributed environment—including within the example distributed computing system 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the enterprise server 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the enterprise server 102. Specifically, the processor 106 executes the functionality required to receive and respond to requests from the client 140 and/or provide forecasting of sales based on historical customer business data.

The enterprise server 102 also includes a memory 107 that holds data for the enterprise server 102. Although illustrated as a single memory 107 in FIG. 1, two or more memories may be used according to particular needs, desires, or particular implementations of the example distributed computing system 100. While memory 107 is illustrated as an integral component of the enterprise server 102, in alternative implementations, memory 107 can be external to the enterprise server 102 and/or the example distributed computing system 100.

The memory 107 holds data for the enterprise server 102. In some implementations, the memory 107 includes account data 112 including a sales order data 112a, stock level data 112b, product data 112c, and business application data 114. Although illustrated as single instances, there may be more than one instance of the account data 112, the sales order data 112a, the stock level data 112b, the product data 112c, and the business application data 114.

The account data 112 is business data associated with a particular purchaser's account with a supplier. For example, account data may include purchaser name, address, business type, contact information, shipping information; billing information, etc. As stated above, account data 112 may also include sales order data 112a, stock level data 112b, and product data 112c. Sales order data 112a may include may include data pertaining to a particular sales order number, sales order date, product identification, product description, stock level, average sales volume, a reorder indicator, or other suitable data consistent with sales order data. Stock level data 112b may include a value indicating a number of units of a particular product in a purchaser's inventory or other suitable data consistent with stock level data. Product data 112c for a particular product may include a product identification number, a product description, supplier information for the particular product, or other suitable data consistent with product data.

The business application 108 is any type of application that allows the client 140 to request and view content on the client 140. In some implementations, the business application 108 can be and/or include a web browser. In some implementations, the business application 108 can use account data 112, business application data, and other information received prior to launch to perform tasks associated with the enterprise server 102 or other components communicably coupled with enterprise server 102. Once a particular business application 108 is launched, a client 140 may interactively process a task, event, or other information associated with the enterprise server 102. The business application 108 can also be any application, program, module, process, or other software that may execute, change, delete, generate, or otherwise manage information associated with a particular enterprise serve 102, and in some cases, a business process performing and executing business process-related events. In particular, business processes communicate with other clients 140, applications, systems, and components to send and receive events. Additionally, a particular business application 108 may operate in response to and in connection with at least one request received from other business applications 108, including a business application 108 associated with another enterprise server 102. In some implementations, each business application 108 can represent a Web-based application accessed and executed by remote clients 140 using the network 130 (e.g., through the Internet, or using at least one cloud-based service associated with the business application 108). For example, a portion of a particular business application 108 may be a Web service associated with the business application 108 that is remotely called, while another portion of the business application 108 may be an interface object or agent bundled for processing at a remote client 140. Moreover, any or all of a particular business application 108 may be a child or sub-module of another software module or enterprise application (not illustrated) without departing from the scope of this disclosure. Still further, portions of the particular business application 108 may be executed or accessed by a user working directly at the enterprise server 102, as well as remotely at a corresponding client 140. In some implementations, the enterprise server 102 can execute the business application 108. Further, although illustrated as a single business application 108, the business application 108 may be implemented as multiple business applications 108 in the enterprise server 102.

The calculation engine 110 is an algorithmic software engine providing functionality to calculate one or more of at least an average sales volume for a product, whether to reorder the product, or a suggested product re-order quantity (i.e., a replenishment calculation). A replenishment calculation is performed by a supplier to determine a desired re-order quantity of a particular product to recommend to a purchaser to mitigate the possibility the purchaser will exhaust an inventory of the particular product. Generally current stock level and prior sales order data for the particular product is used in the replenishment calculation. For example, the calculation engine 110 may determine a recommended replenishment quantity of forty-seven product units for a particular product identified in account data 112. This determination may be based upon a current purchaser stock level quantity of twenty-two particular product units sent to the enterprise server 102 from client 140 and the quantity of the particular product units ordered in prior sales orders. In some implementations, other factors considered in the replenishment calculation can include, for example, the latency between the placement of an order for a product from a purchaser to a supplier and the expected delivery time for the ordered product and/or the length in time between supplier representative visits to the purchaser to take product orders. Other factors and/or data may be used by the calculation engine 110 to perform the replenishment calculation. The calculation engine 110 may also perform other suitable calculations consistent with the scope of this disclosure. In some implementations, the calculation engine 110 can interface with memory 107 and perform calculations with data accessed from memory 107 and data received in one or more requests from client 140.

In some implementations, the calculation engine 110 can use internal rule sets (not illustrated) and/or external rule sets (not illustrated). In some implementations, the calculation engine can use decision tables and trees, read data while performing calculations, perform database calls/functions, call services or interfaces in multiple computing languages and/or protocols, and other suitable algorithmic/rule-based functions. For example, a modeled decision service executing on a managed system may perform database updates following a calculation of a recommended re-order quantity. In some implementations, the calculation engine 110 may be partially or completely provided in a cloud-computing environment. Further, although illustrated as a single calculation engine 110, the calculation engine 110 may be implemented as multiple calculation engines 110 in the enterprise server 102.

Example Replenishment Calculation

In some implementations, an example method for a calculation engine 110 to perform a replenishment calculation is as follows:

Assumptions

A supplier representative visits the purchaser associated with a particular account at intervals Δᵢ of Δᵢ=tᵢ−tᵢ₋₁. In this formula, tᵢ and tᵢ₋₁ represent times of the supplier representative visits. At the time of a particular visit (i), there exists a stock level Lᵢ and a previous order volume Vᵢ₋₁ representing a value equal to the order volume of the last visit. The shipping duration is represented as latency Λ and is assumed to be constant.

Solution

The average sales rate R_{avg} is obtained by taking the last stock level and the last order volume (retrieved from prior sales orders 112a) and subtracting the current stock level received from client 140, taking into account the interval Δ_{I}, averaged over the last N visits (in order not to average over expected seasonal fluctuations).

$${R}_{avg} = \frac{1}{N} {\sum }_{j = i - N}^{i - 1} \frac{{L}_{j + 1} + {V}_{j} - {L}_{j}}{{Δ}_{j}}$$

Two cases must be considered to ensure the purchaser will not exhaust their stock.

1. Where the Latency is Greater than the Intervals Between Supplier Representative Visits (Λ>Δᵢ):
The stock level at the next visit is the current stock level minus the sold assets:

Lᵢ₊₁=Lᵢ−R_{avg}Δᵢ
The stock level in the visits after the next visit will be the next stock level minus the sold items plus the ordered items from the current visit (due to the latency duration):

Lᵢ₊₂=Lᵢ₊₁−R_{avg}Δᵢ+Vᵢ
Not running out of stock until the shipment arrives implies the condition:

Lᵢ₊₂>R_{avg}Λ
Therefore, the following condition guarantees the stock will not be depleted:

Vᵢ=R_{avg}(2Δᵢ+Λ)−Lᵢ

Assuming that the latency is no longer than two subsequent visits (i.e. the shipment arrives before the i+2nd time the supplier representative visits the supplier):

2. Where the Latency is Less than the Intervals Between Supplier Representative Visits (Λ<Δᵢ):
The stock level at the next visit is the current stock level minus the sold items plus the order volume from the current visit:

Lᵢ₊₁=Lᵢ−R_{avg}Δᵢ+Vᵢ
Not running out of stock until the shipment arrives implies the condition:

Lᵢ₊ᵢ>R_{avg}Λ
Therefore, the following condition guarantees the stock will not be depleted:

Vᵢ>R_{avg}(Δᵢ+Λ)−Lᵢ

In other implementations consistent with this disclosure, the calculation engine 110 can perform a replenishment calculation with different methods, parameters, variables, assumptions, etc. as will be apparent to one of skill in the art.

The business application data 114 is any type of data associated with and/or used by the business application 108. For example, business application data 114 may include data repository locations, security and permissions information, or other suitable data. The Business application data 114 may also include account data 112, further including associated sales order data 112a, stock level data 112b, and product data 112c.

While the business application 108 and calculation engine 110 are illustrated as separate modules these components could be implemented and/or illustrated as integrated modules without departing from the scope of this disclosure. Similarly, while the components for sales order data 112a, stock level data 112b, and product data 112c are illustrated as integral to the account data 112 component, the sales order data 112a, the stock level data 112b, and the product data 112c components could be implemented and/or illustrated as stand-alone components within memory 107 without departing from the scope of this disclosure.

The example distributed computing environment 100 also includes the client 140. While clients 140a-140c are illustrated as representative of client 140, client 140 may take other forms without departing from the scope of this disclosure. Client 140 may be any computing device operable to connect to or communicate with at least the enterprise server 102 using the network 130. In general, the client 140 comprises a mobile-type electronic computer device operable to receive, transmit, process, and store any appropriate data associated with the example distributed computing system 100. The client 140 may, however, also be a non-mobile-type electronic computer device.

The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the enterprise server 102. Once a particular client application 146 is launched, a user may interactively process a task, event, or other information associated with the enterprise server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the example distributed computing system 100—connected to the network 130; for example, the enterprise server 102 as well as other systems communicably coupled to the network 130 (not illustrated). The interface 152 may also be consistent with the above-described interface 104 of the enterprise server 102 or other interfaces within the example distributed computing system 100. The processor 144 may be consistent with the above-described processor 106 of the enterprise server 102 or other processors within the example distributed computing system 100. Specifically, the processor 144 executes instructions and manipulates data to perform the operations of the client 140, including the functionality required to send requests to the enterprise server 102 and to receive and process responses from the enterprise server 102. The memory 148 may be consistent with the above-described memory 107 of the enterprise server 102 or other memories within the example distributed computing system 100 but storing objects and/or data associated with the purposes of the client 140.

Further, the illustrated client 140 includes a GUI 142. The GUI 142 interfaces with at least a portion of the example distributed computing system 100 for any suitable purpose, including generating a visual representation of a custom application and/or web browser. In particular, the GUI 142 may be used to view and navigate various web pages located both internally and externally to the enterprise server 102 and/or custom application dialogs/windows.

There may be any number of clients 140 associated with, or external to, the example distributed computing system 100. For example, while the illustrated example distributed computing system 100 includes one client 140, alternative implementations of the example distributed computing system 100 may include multiple clients 140 communicably coupled to the enterprise server 102 and/or the network 130, or any other number suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the business suite server 102 or the client 140 itself, including digital data, visual information, or a GUI 142, as shown with respect to the client 140.

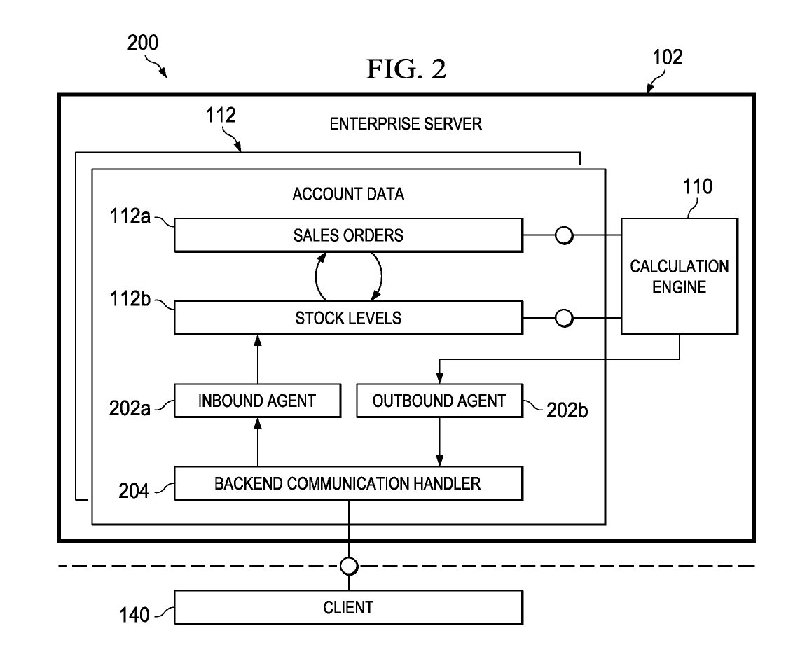

Turning now to FIG. 2, FIG. 2 is a block diagram 200 further illustrating an example system for mobile forecasting of sales based on historical customer business data. Client 140 communicates with the enterprise server 102 through a backend communication handler 204 incorporated into enterprise server 102. In some implementations, the backend communication handler 204 can be external to and interface with the enterprise server 102. In some implementations, the communication between the client 140 and the backend communication handler is over the secure hypertext transfer protocol (HTTPS). In other implementations, other suitable communication protocols may be used without departing from the scope of this disclosure.

The backend communication handler 204 interfaces with both an inbound agent 202a and an outbound agent 202b. In some implementations, the inbound agent 202a deconstructs an HTTPS request from HTTPS to extensible markup language (XML). In some implementations, the outbound request agent 202b deconstructs XML from XML to an HTTPS request. In some implementations, functionality provided by the backend communication handler 204, the inbound agent 202a, and the outbound agent 202b can be encapsulated in the functionality of interface 104 and/or interface with interface 104.

Further, calculation engine 110 may directly access sales order data in a sales order repository 112a and stock level data in a stock level repository 112b. The circular relationship illustrated between the sales order repository 112a and the stock level repository 112b indicates that sales order data in the sales order repository 112a may be accessed and modified by the stock repository 112b and vice versa. In some implementations, calculation engine 110 can directly access product data 112c (not illustrated).

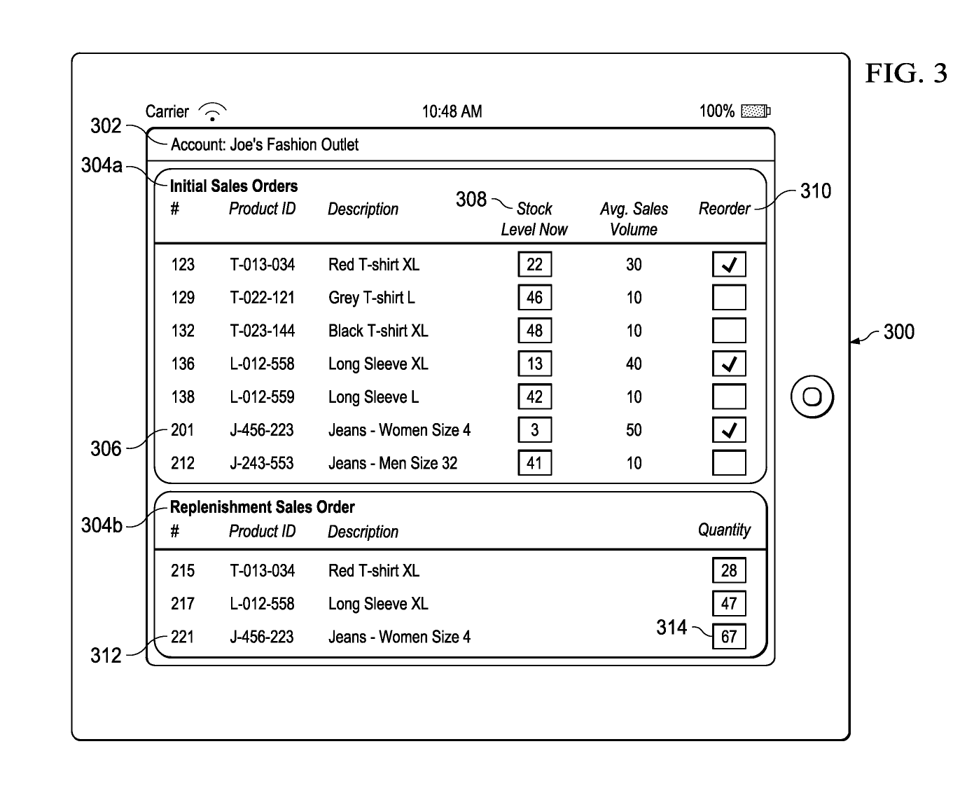

Turning now to FIG. 3, FIG. 3 illustrates an example GUI 300 screenshot from client application 146 executing on a tablet-type computer. In this example, a supplier representative is viewing data supplied by enterprise server 102 for account 302 associated with purchaser “Joe's Fashion Outlet.” The client application 146 display is split into initial sales orders 304a and replenishment sales order 304b. The initial sales orders 304a details prior sales orders placed and descriptive information associated with each initial sales order 304a. For example, initial sales order 201 (306) shows information for number (201), product identification (J-456-223), description (Jeans-Women Size 4), average sales volume (50), etc. The supplier representative is also presented with a data entry field 308 (Stock Level Now) to supply a current purchaser inventory level for each product indicated. For example the supplier representative may enter a value of “3” into the data entry field 308 to indicate the current stock level for “Jeans-Women Size 4” for supplier Joe's Fashion Outlet. The value of “3” is then sent by the client 140 to enterprise server 102. A reorder field 310 is also available to the supplier representative to indicate whether a specific product should be reordered according to a suggested replenishment sales order.

The replenishment sales order 304b details suggested sales orders to replenish particular products. For example, replenishment sales order 221 (312) shows information for number (221), product identification (J-456-223), description (Jeans-Women Size 4), etc. In an example usage scenario, after entering the value of 3 into the data entry field 308, the supplier representative notices that the average sales volume for initial sales order 306 is 50 units and that the interface 304b has suggested a replenishment sales order 221 (312) for “Jeans-Women Size 4” for supplier Joe's Fashion Outlet with a suggested quantity of sixty-seven units. Based upon the average sales volume and the stock level now 308 value of “3” for this product, the supplier representative selects the reorder checkbox 310 indicating that replenishment sales order 221 should be processed. In some implementations, the enterprise server 102 may send an indication to automatically default the reorder checkbox as selected depending on some minimum threshold value or some other criteria.

The GUI 300 illustrated in FIG. 3 is for illustration purposes only. Elements of GUI 300 may be re-arranged, substituted, operated in a different manner and/or order, and/or be deleted without departing from the scope of this disclosure. Moreover, the example distributed computing environment 100 may use a GUI and/or GUIs with additional elements, fewer elements, and/or different elements, so long as necessary functionality is provided by the GUI 300.

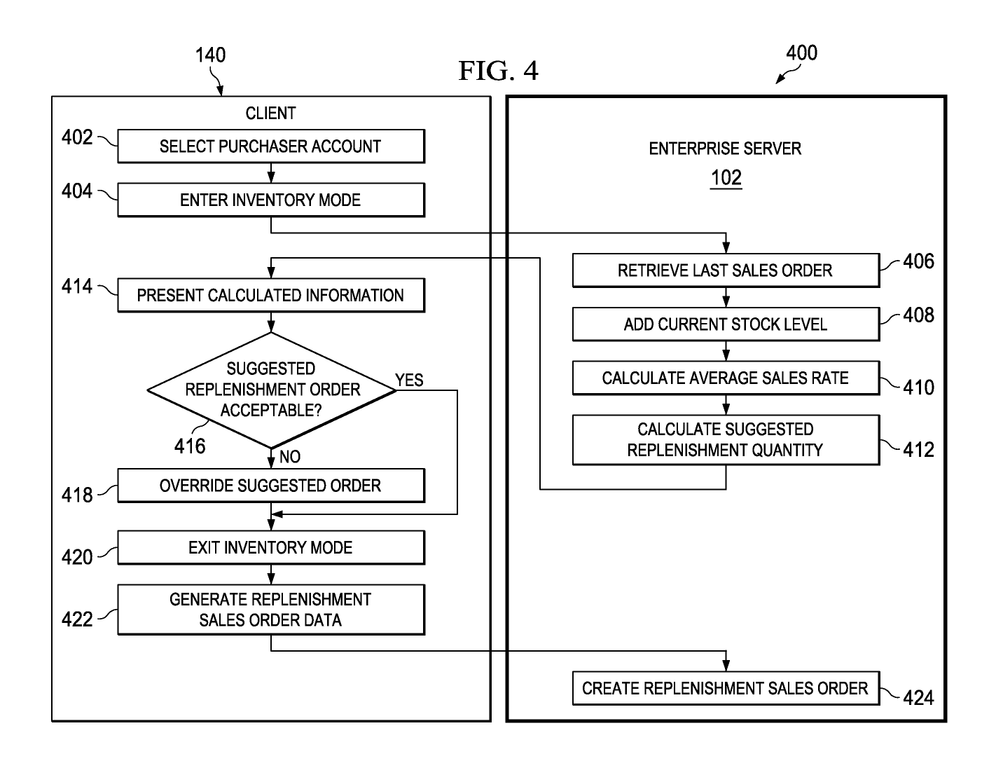

Turning now to FIG. 4, FIG. 4 is a flow chart for mobile forecasting of sales based on historical customer business data. For clarity of presentation, the description that follows generally describes method 400 in the context of FIGS. 1, 2, and 3 with a supplier representative using a GUI application on a client. However, it will be understood that method 400 may be performed, for example, by any other suitable system, environment, software, and hardware, or a combination of systems, environments, software, and hardware as appropriate. For example, one or more of the enterprise server, the client, or other computing device (not illustrated) can be used to execute method 400 and obtain any data from the memory of the client, the enterprise server, or the other computing device.

At 402, a user (i.e., a supplier representative) selects a relevant purchaser account in a GUI. In some implementations, the supplier representative can be presented with multiple purchaser accounts from which to choose from. In other implementations, a global positioning system or other location-type awareness system associated with the client can suggest appropriate clients based on the location of the supplier representative. Once the purchase account is selected, initial information associated with the account can be displayed to the supplier representative. This initial information may include purchaser name, purchaser logo, contact person/information, important supplier-specific information related to the client, or other suitable information. In some implementations, some or all of the initial information associated with the purchaser account may be stored on the client, while in other implementations, the client may create a connection between the client and the enterprise server and query the enterprise server to transmit some or all of the initial information related to the purchaser account. From 402, method 400 proceeds to 404.

At 404, the supplier representative enters an inventory mode in the GUI. An example of an inventory mode GUI is illustrated in FIG. 3. The supplier representative enters current purchaser stock levels for specific products. A connection is created between the client and the enterprise server and the entered current stock level information is transmitted to the enterprise server. From 404, method 400 proceeds to 406.

At 406, the last sales order(s) associated with the purchaser account is retrieved from memory. From 406, method 400 proceeds to 408.

At 408, the current stock levels received from the client are added to the enterprise server memory and stored in the stock level repository 112b. In some implementations, the current stock levels are used in successive steps in order to calculate respective quantities appropriate to a particular step. From 408, method 400 proceeds to 410.

At 410, the average sales rate for specific products is calculated using at least the last sales order(s), the received current stock levels and the time interval between the visits. From 410, method 400 proceeds to 412.

At 412, a suggested replenishment quantity is calculated for the specific products using the current stock levels, the average sales rate, the time between visits, and the latency. From 412, method 400 proceeds to 414.

At 414, a suggested replenishment quantity is presented to the supplier representative in the GUI. From 414, method 400 proceeds to 416.

At 416, a determination is made whether the presented suggested replenishment quantity is acceptable. If at 416, it is determined that the presented suggested replenishment quantity is acceptable, method 400 proceeds to 420. If at 416, however, it is determined that that the presented suggested replenishment quantity is not acceptable, method 400 proceeds to 418.

At 418, the supplier representative may override the suggested replenishment order quantity values in the GUI. For example, the purchaser may believe that a larger quantity of a particular product should be ordered. The supplier representative may then update the suggested replenishment order quantity value. From 418, method 400 proceeds to 420.

At 420, the supplier representative exits the inventory mode in the GUI. In some implementations, this may be accomplished by a confirming action, changing a tab element, selecting another purchaser account, or other suitable action. From 420, method 400 proceeds to 422.

At 422, the client generates a replenishment sales order data for the particular purchaser account, creates a connection with the enterprise server, and transmits the generated replenishment sales order data to the enterprise server. From 422, method 400 proceeds to 424.

At 424, the transmitted replenishment sales order data for the particular purchaser account is used to create a replenishment sales order on the enterprise server. The created replenishment sales order may then be processed to ship the associated particular products to the purchaser. After 424, method 400 stops.

Although FIG. 4 is described to illustrate the interaction between a single client and a single enterprise server, it is possible for a client to interface with multiple enterprise servers, for multiple clients to interface with a single enterprise server, or for multiple clients to interface with multiple enterprise servers.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
selecting an account for a purchaser in a graphical user interface (GUI);
entering, using the GUI in an inventory mode, a current stock level for a product associated with the selected account;
presenting calculated information associated with the product, the calculated information including a suggested replenishment quantity for the product, the calculation of the suggested replenishment quantity taking into account an interval between visits to the purchaser by a supplier and a comparison of a shipping duration to the interval;
exiting the inventory mode in the GUI;
generating, by operation of a computer, replenishment sales order data; and
creating a replenishment sales order for the product.

2. The computer-implemented method of claim 1, further comprising requesting initial information associated with the selected purchaser account from a data source.

3. The computer-implemented method of claim 2, further comprising creating a connection with the data source to request the initial information.

4. The computer-implemented method of claim 1, further comprising retrieving a last sales order for the product.

5. The computer-implemented method of claim 1, further comprising calculating an average sales volume for the product.

6. The computer-implemented method of claim 1, further comprising calculating a suggested replenishment quantity for the product.

7. The computer-implemented method of claim 1, wherein the calculated information further includes an average sales volume for the product.

8. The computer-implemented method of claim 1, further comprising:
determining that the suggested replenishment quantity is not acceptable; and
overriding the suggested replenishment quantity.

9. A computer-program product, the computer program product comprising computer-readable instructions embodied on tangible, non-transitory media, the instructions operable when executed to perform operations to:
select an account for a purchaser in a graphical user interface (GUI);
enter, using the GUI in an inventory mode, a current stock level for a product associated with the selected account;
present calculated information associated with the product, the calculated information including a suggested replenishment quantity for the product, the calculation of the suggested replenishment quantity taking into account an interval between visits to the purchaser by a supplier and a comparison of a shipping duration to the interval;
exit the inventory mode in the GUI;
generate replenishment sales order data; and
create a replenishment sales order for the product.

10. The computer-program product of claim 9, further comprising instructions operable to request initial information associated with the selected purchaser account from a data source.

11. The computer-program product of claim 10, further comprising instructions operable to create a connection with the data source to request the initial information.

12. The computer-program product of claim 9, further comprising instructions operable to retrieve a last sales order for the product.

13. The computer-program product of claim 9, further comprising instructions operable to calculate an average sales volume for the product.

14. The computer-program product of claim 9, further comprising instructions operable to calculate a suggested replenishment quantity for the product.

15. The computer-program product of claim 9, wherein the calculated information further includes an average sales volume for the product.

16. The computer-program product of claim 9, further comprising instructions operable to:
determine that the suggested replenishment quantity is not acceptable; and
override the suggested replenishment quantity.

17. A system, comprising:
memory configured to store at least one account; and
at least one hardware processor interoperably coupled to the memory and configured to:
select an account of the at least one account for a purchaser in a graphical user interface (GUI);
enter, using the GUI in an inventory mode, a current stock level for a product associated with the selected account;
present calculated information associated with the product, the calculated information including a suggested replenishment quantity for the product, the calculation of the suggested replenishment quantity taking into account an interval between visits to the purchaser by a supplier and a comparison of a shipping duration to the interval;
exit the inventory mode in the GUI;
generate replenishment sales order data; and
create a replenishment sales order for the product.

18. The system of claim 17, further configured to request initial information associated with the selected purchaser account from a data source.

19. The system of claim 18, further configured to create a connection with the data source to request the initial information.

20. The system of claim 17, further configured to retrieve a last sales order for the product.

21. The system of claim 17, further configured to calculate an average sales volume for the product.

22. The system of claim 17, further configured to calculate a suggested replenishment quantity for the product.

23. The system of claim 17, wherein the calculated information further includes an average sales volume for the product.

24. The system of claim 17, further configured to:
determine that the suggested replenishment quantity is not acceptable; and
override the suggested replenishment quantity.
